(19) United States
(12) Patent Application Publication
(10) Pub. No.: US 2026/0094919 A1
(43) Pub. Date: Apr. 2, 2026

(54) BATTERY MODULE AND TELEMATICS TERMINAL HAVING SAME

(71) Applicant: LG ELECTRONICS INC., Seoul (KR)

(72) Inventors: Jongwook JEON, Seoul (KR); Minwoo HONG, Seoul (KR); Choyoung PARK, Seoul (KR)

(73) Assignee: LG ELECTRONICS INC., Seoul (KR)

(21) Appl. No.: 18/929,091

(22) Filed: Oct. 28, 2024

(30) Foreign Application Priority Data
Sep. 11, 2024 (WO) PCT/KR2024/013835

(51) Int. Cl. H01M 50/264; B60R 16/033; H01M 50/213; H01M 50/296

(52) U.S. Cl. CPC H01M 50/264; H01M 50/213; H01M 50/296; B60R 16/033; H01M 2220/20

(57) ABSTRACT

A battery module according to the present embodiment may comprise a housing having a battery space formed between an upper case and a lower case; a plurality of latches extending from the housing; a connection portion connected to the plurality of latches; and a strap connected to the connection portion and thus the battery module may be easily mounted by a plurality of latches, and a strap may assist in withdrawing the battery module.

### CROSS-REFERENCE TO RELATED APPLICATIONS

This application claims the benefit of priority to Patent Cooperation Treaty No. PCT/KR2024/013835, filed in the Korean Intellectual Property Office on Sep. 11, 2024 under 35 U.S. C. 119 and/or 35 U.S.C. 120, the entire contents of which are incorporated herein by reference.

### BACKGROUND

The present disclosure relates to a battery module and a telematics terminal including the same.

Telematics refers to the provision of various mobile services such as location information, safe driving, entertainment, financial services, reservations, and product purchases in automobiles by combining wireless communication and Global Positioning System (GPS) technology.

A telematics terminal may be installed in an automobile, and Korean Patent Publication No. 10-0669609 B1 (announced on Jan. 15, 2007) discloses a telematics terminal connected to a vehicle power supply part installed in an automobile, and the telematics terminal may be operated by power supplied from the vehicle power supply part.

### SUMMARY

An object of the present embodiment is to provide a battery module that may be more firmly maintained in a telematics terminal and may be easily separated from the telematics terminal.

An object of the present embodiment is to provide a telematics terminal having a battery module having a simple structure because a battery module cover covering the battery module is not required, and easy to service.

A telematics terminal having a battery module according to the present embodiment may comprise a battery module; a TCU housing having a pocket formed therein in which the battery module is detachably mounted and an inner space formed therein; and a substrate accommodated in the inner space.

A battery module according to the present embodiment may comprise a housing having a battery space formed between an upper case and a lower case; a plurality of latches extending from the housing; a connection part connected to the plurality of latches; and a strap connected to the connection part.

The housing may be snap-fit coupled to a TCU housing to which the latch is restrained.

The housing may be separated from the TCU housing using the strap.

A strap penetration hole through which the strap penetrates may be formed in the upper case.

The strap may be capable of applying force in a plurality of directions.

An upper area of the strap penetration hole may be larger than a lower area of the strap penetration hole.

A terminal seating portion may be formed in the housing.

The battery module may comprise a power supply terminal disposed on the terminal seating portion.

The housing may further comprise a guide that is spaced apart from the terminal seating portion and is inserted into a position alignment hole formed in the TCU housing.

The latch may comprise an elastic body extending from the housing and a protruding body protruding from the elastic body.

The protruding body may comprise a center body and a pair of side bodies.

The upper end of the center body may be perpendicular to a rear surface of the elastic body.

The upper end of the side body may have an obtuse angle with the rear surface of the elastic body.

A latch hole into which a protruding body of the latch is inserted and restrained may be formed in the TCU housing.

The strap may comprise a fixed region that is fixed to the lower case; a connection region that surrounds the connection part; and a free end region that extends from the connection region.

The housing is such that when the free end region is lifted, the latch may be released from the latch hole.

The pocket may be formed with a penetration portion through which the terminal seating portion passes.

### BRIEF DESCRIPTION OF THE DRAWINGS

FIG. 1 is a block diagram schematically illustrating the internal configuration of a telematics terminal according to the present embodiment,

FIG. 2 is a block diagram illustrating a configuration related to power control of a telematics terminal according to the present embodiment,

FIG. 3 is a perspective view illustrating a battery module according to the present embodiment,

FIG. 4 is a plan view illustrating a battery module according to the present embodiment,

FIG. 5 is a rear view illustrating a battery module according to the present embodiment,

FIG. 6 is a bottom view illustrating a battery module according to the present embodiment,

FIG. 7 is a perspective view illustrating a telemethyls terminal having a battery module according to the present embodiment,

FIG. 8 is a cross-sectional view taken along line A-A of FIG. 7,

FIG. 9 is a view illustrating the front plate part of a pocket according to the present embodiment,

FIG. 10 is a view illustrating the rear plate part of the pocket according to the present embodiment.

FIG. 11 is a cross-sectional view illustrating a state where the latch is restrained in a pocket according to the present embodiment, and

FIG. 12 is a cross-sectional view illustrating the process of removing a battery module from a TCU housing according to the present embodiment.

### DETAILED DESCRIPTION OF THE EMBODIMENTS

Hereinafter, specific embodiments of the present disclosure will be described in detail with reference to the drawings.

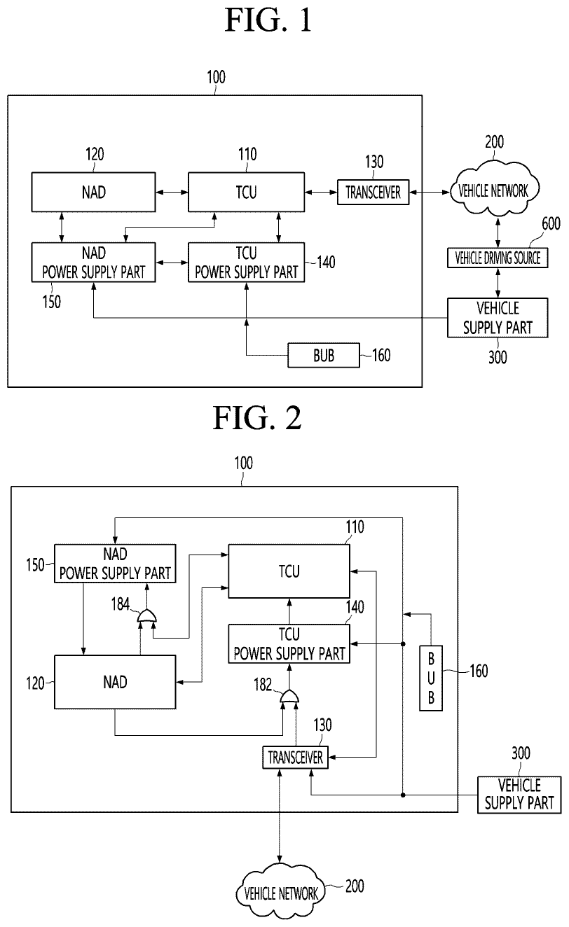

FIG. 1 is a block diagram schematically illustrating the internal configuration of a telematics terminal 100 according to the present embodiment.

According to FIG. 1, a telematics terminal 100 is configured to comprise a telematics control unit (hereinafter referred to as “TCU”) 110, a network access part (hereinafter referred to as “NAD”) 120, a transceiver 130, a telematics control power supply part 140 (hereinafter referred to as “TCU power supply part”), and a network access power supply part 150 (hereinafter referred to as “NAD power supply part”).

The TCU 110 may perform the role of a host processor of a telematics terminal 100.

The TCU 110 may be equipped with a keypad connection terminal, an audio codec connection terminal, an EEPROM (Electrically Erasable Programmable Read-Only Memory) connection terminal, a UART (Universal Asynchronous Receiver/Transmitter) connection terminal, a NAD connection terminal, a transceiver connection terminal, an SDRAM (Synchronous Dynamic Random Access Memory) connection terminal, a test tool interface connection terminal, or the like.

The TCU 110 may be connected to the NAD 120, transceiver 130, TCU power supply part 140, and NAD power supply part 150 through a connection terminal, and may perform vehicle network communication, or the like.

TCU 110 may process communication data to provide telematics services.

NAD 120 may assist in processing communication data of TCU 110. NAD 120 may be equipped with a UART connection terminal, a Tx (transmission) terminal, an Rx (reception) terminal, a PCM (Pulse Code Modulation) connection terminal, or the like.

The TCU power supply part 140 and the NAD power supply part 150 may each be connected to the vehicle power supply part 300.

The TCU power supply part 140 may enable or disable power to the TCU 110.

The NAD power supply part 150 may enable or disable power to the NAD 120.

FIG. 2 is a block diagram illustrating a configuration related to power control of a telematics terminal 100 according to the present embodiment.

According to FIG. 2, the vehicle power supply part 300 is connected to the transceiver 130, the TCU power supply part 140, and the NAD power supply part 150, and may provide 12 V battery power.

The TCU power supply part 140 and the NAD power supply part 150 are connected to the TCU 110 and the NAD 120, respectively, to control power, and the TCU 110 may be connected to the transceiver 130 and the NAD 120.

A Telematics Terminal 100 May Configure a Power Control Circuit by Having Two OR gates 182 and 184.

The transceiver 130 and NAD 120 may be connected to the input terminal of the first OR gate 182, and the output terminal of the first OR gate 182 may be connected to the TCU power supply part 140.

Additionally, the TCU 110 and NAD 120 may be connected to the input terminal of the second OR gate 184, and the output terminal of the second OR gate 184 may be connected to the NAD power supply part 150.

The transceiver 130 may be connected to a vehicle network 200 and receives messages from various vehicle devices or interface devices and transmits messages to the TCU 110.

The vehicle network 200 is connected to a vehicle driving source 600 such as an engine or motor and may detect the On/Off or abnormal signal of the starter.

Class 2, HSGMLAN, LSGMLAN, or the like may be used as the vehicle network 200, and therefore the transceiver 130 may also be equipped as a Class 2 transceiver, an HSGMLAN transceiver, an LSGMLAN transceiver, or the like, respectively.

The transceiver 130 converts a vehicle network input signal into Tx (transmitter) and Rx (receiver) data and transmits them to the TCU 110, and when it receives a power cutoff signal from the TCU 110, it disables the TCU power supply part 140 so that only the NAD 120 may be switched to the DRx mode.

The telematics terminal 100 may comprise a substrate and a TCU housing.

A TCU 110, a TCU power supply part 140, and an NAD power supply part 150 may be formed on the substrate, and the NAD 120 may be disposed on the upper side of the TCU 110.

The TCU housing forms the outer appearance of the telematics terminal 100 and may protect various parts such as substrates.

### The Telematics Terminal 100 May Further Comprise a Bub (back up Battery) 160.

BUB (Back UP Battery) 160 may supply power to the telematics terminal 100 in an emergency, such as when power is not supplied from the vehicle power supply part 300.

BUB 160 may be a battery module including at least one battery, and BUB 160 may be detachably mounted to the TCU housing.

Hereinafter, BUB 160 is referred to as a battery module 160.

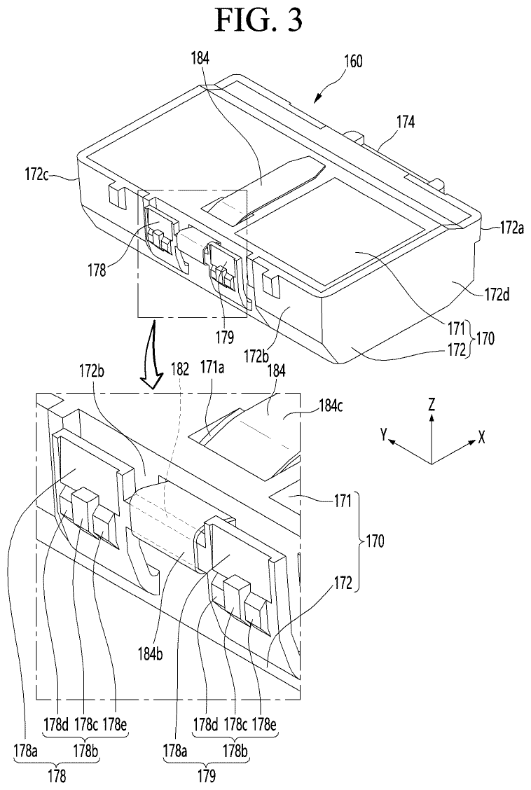

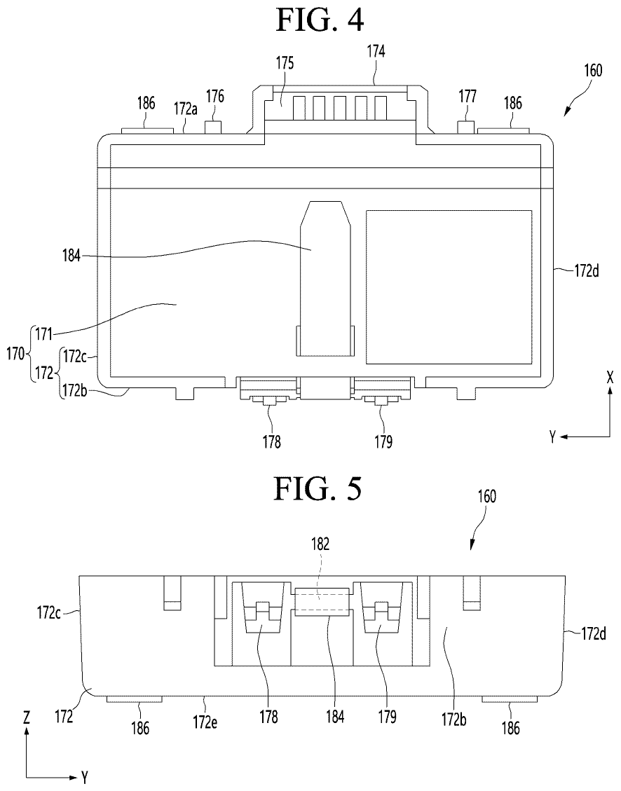

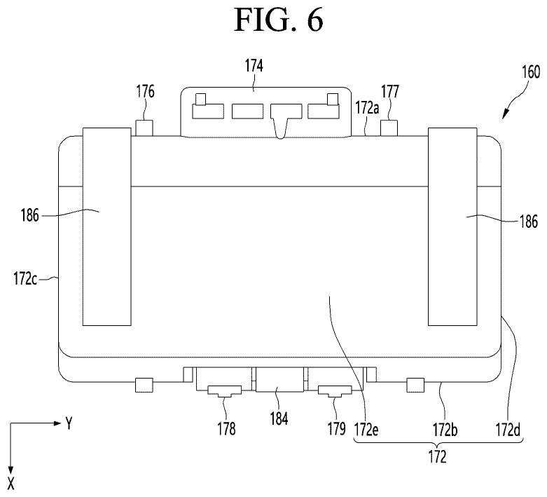

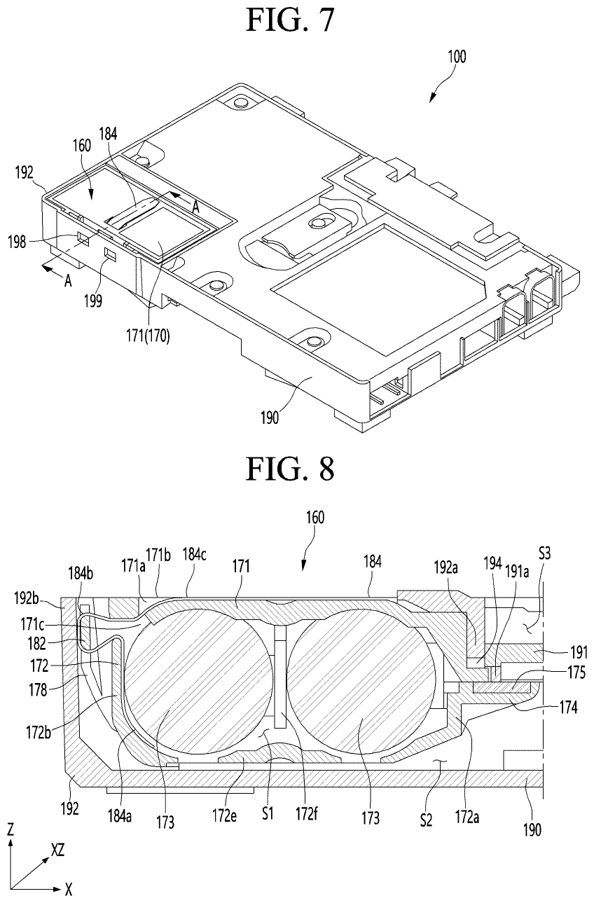

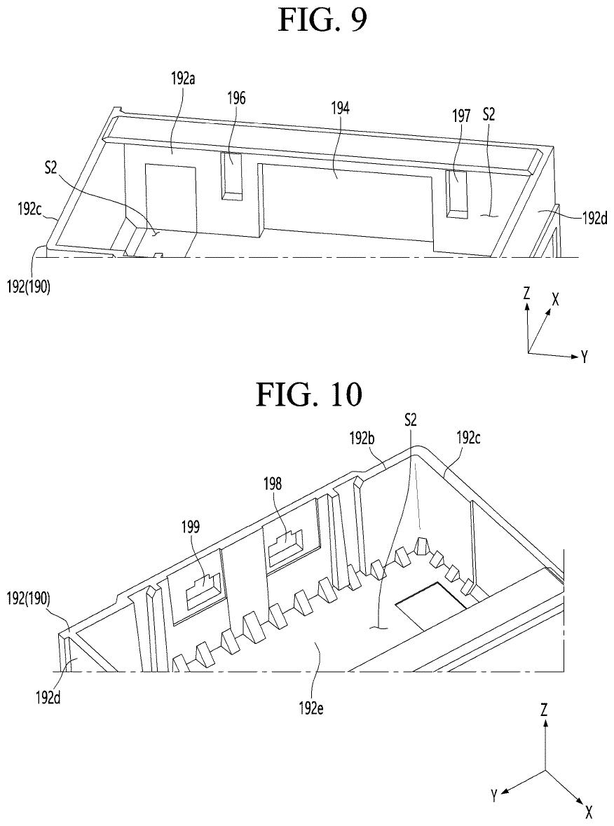

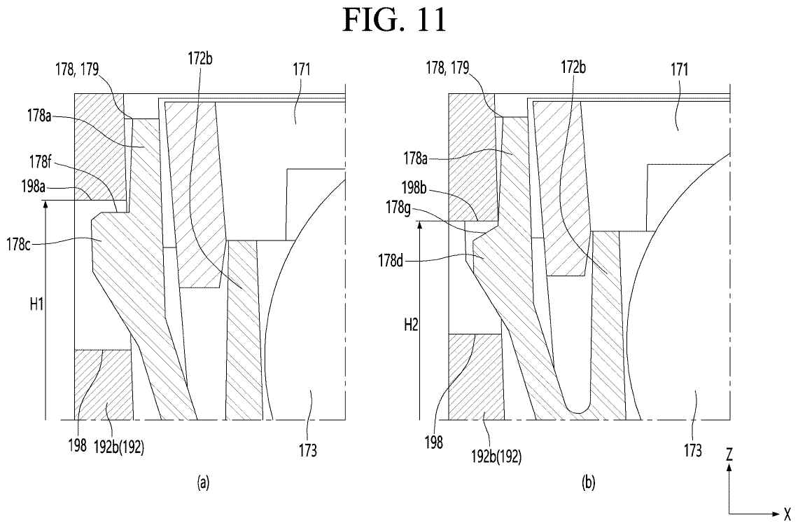

FIG. 3 is a perspective view illustrating a battery module according to the present embodiment, FIG. 4 is a plan view illustrating a battery module according to the present embodiment, FIG. 5 is a rear view illustrating a battery module according to the present embodiment, FIG. 6 is a bottom view illustrating a battery module according to the present embodiment, FIG. 7 is a perspective view illustrating a telemethyls terminal having a battery module according to the present embodiment, FIG. 8 is a cross-sectional view taken along line A-A of FIG. 7, FIG. 9 is a view illustrating the front plate part of a pocket according to the present embodiment, and FIG. 10 is a view illustrating the rear plate part of the pocket according to the present embodiment.

The battery module 160 may comprise a housing 170.

A battery space S1 in which a battery 173 is accommodated may be formed inside the housing 170.

The housing 170 may comprise an upper case 171 and a lower case 172.

The battery space S1 may be formed between the upper case 171 and the lower case 172.

The upper case 171 may be disposed on the upper portion of the lower case 172. The upper case 171 may cover a battery space S1 formed inside the lower case 172. The upper case 171 may be a battery cover that protects the battery 173.

The upper case 171 may be detachably connected to the lower case 172, rotatably connected to the lower case 172, or slidably connected to the lower case 172, and may open and close the battery space S1.

The lower case 172 may be formed in an approximately rectangular shape, and the battery space S1 may be formed inside the lower case 172.

The lower case 172 may comprise a front plate 172a, a rear plate 172b spaced apart from the front plate 172a in the front and rear direction X, a left plate 172c connecting the left end of the front plate 172a and the left end of the rear plate 172b, and a right plate 172d connecting the right end of the front plate 172a and the right end of the rear plate 172b. The lower case 172 may further comprise a lower plate 172e forming the outer appearance of the lower surface of the lower case 172.

The front plate 172a, the rear plate 172b, the left plate 172c, the right plate 172d, and the lower plate 172e may form a battery space S1.

The lower case 172 may comprise a partition plate 172f spaced apart from each of the front plate 172a and the rear plate 172b. The partition plate 172f may be formed to be long in the battery space S1 in the left and right direction Y.

The battery space S1 may be partitioned into a front space and a rear space by a partition plate 172a.

A plurality of batteries 173 may be accommodated in the battery space S1. The plurality of batteries may comprise a front battery accommodated in the front space and a rear battery accommodated in the rear space.

A terminal seating portion 174 may be formed in the housing 170. The terminal seating portion 174 may protrude forward from the front plate 172a of the lower case 172.

The battery module 160 may further comprise a power supply terminal 175. The power supply terminal 175 may be disposed in the terminal seating portion 174. The power supply terminal 175 may be fixed to the terminal seating portion 174.

The power supply terminal 175 may be in electrical contact with the substrate 191 disposed inside the TCU housing 190.

When the battery module 160 is completely mounted in the TCU housing 190, the power supply terminal 175 may be electrically connected to the substrate 191 and supply power to the substrate 191.

The housing 170 may further comprise a guide. The guide may be inserted into the TCU housing 190. The guide may be inserted into a position alignment hole formed in the TCU housing 190 and may guide the mounting of the battery module 160.

The guide may protrude forward from the front plate 172a of the lower case 172. The guide may be spaced apart from the terminal seating portion 174.

A plurality of guides may be formed in the lower case 172. The plurality of guides 176 and 177 may comprise a pair of guides 176 and 177 spaced apart in the left and right direction Y. The pair of guides 176 and 177 may comprise a left guide 176 and a right guide 177.

A latch that may be restrained to the TCU housing 190 may be formed in the housing 170.

The latch may be formed on the opposite side of the guide 176 and 177 of the housing 170.

The latch may be formed in the upper case 171 or the lower case 172.

Hereinafter, the latch is described as being formed on the rear plate 172b of the lower case 172, but it is not limited thereto and it is of course also possible for the latch to be formed on the upper case 171.

A plurality of latches may be formed in the housing 170. The plurality of latches 178 and 179 may extend from the housing 170. The plurality of latches 178 and 179 may comprise a pair of latches 178 and 179. The pair of latches 178 and 179 may be spaced apart in the left and right direction Y. The pair of latches 178 and 179 may comprise a left latch 178 and a right latch 179.

The left latch 178 and the right latch 179 may be formed in the same shape.

The latch may comprise an elastic body 178a extending from the housing 170 and a protruding body 178b protruding from the elastic body 178a.

The elastic body 178a may protrude from the rear surface of the housing 170.

The lower end of the elastic body 178a may be connected to the rear surface of the housing 170, and the upper end of the elastic body 178a may be spaced apart from the rear surface of the housing 170.

The elastic body 178a may be connected to the rear plate 172b of the lower case 172.

The lower end of the elastic body 178a may be connected to the rear plate 172b of the lower case 172, and the upper end of the elastic body 178a may be spaced apart from the rear plate 172b of the lower case 172.

The protruding body 178b may protrude from the elastic body 178a. The protruding body 178b may protrude from the rear surface of the elastic body 178a.

The protruding body 178b may be inserted into a latch hole formed in the TCU housing 190, and when inserted into the latch hole, may be restrained around the latch hole.

The protruding body 178b may comprise a center body 178c and a side body.

A plurality of side bodies may be formed on the elastic body 178a. The plurality of side bodies 178d and 178e may comprise a pair of side bodies 178d and 178e formed on the elastic body 178a. The pair of side bodies 178d and 178e may be spaced apart in the left and right direction Y. The pair of side bodies 178d and 178e may comprise a left body 178d formed on the left side of the center body 178c and a right body 178e formed on the right side of the center body 178c.

The housing 170 may be coupled to the TCU housing 190 by a plurality of latches 178 and 179. The housing 170 may be snap-fit coupled to the TCU housing 190 to which the latches 178 and 179 are restrained.

The housing 170 may further comprise a connection part 182 connected to a plurality of latches 178 and 179.

The connection part 182 may be positioned between the left latch 178 and the right latch 179. The connection part 182 may be connected to each of the left latch 178 and the right latch 179. The left end of the connection part 182 may be connected to the right portion of the left latch 178, and the right end of the connection part 182 may be connected to the left portion of the right latch 179.

An example of a connection part 182 may be a bar connecting a left latch 178 and a right latch 179 spaced apart in the left and right direction Y.

The connection part 182 may be spaced apart from the upper case 171.

The battery module 160 may comprise a strap 184 connected to the housing 170. The strap 184 may be connected to a connection part 182 of the housing 170. The strap 184 may be fitted to the housing 170 by the connection part 182. The strap 184 may be fitted to the connection part 170 by having a portion of the strap 184 wrapped around the connection part 182. A portion of the strap 184 may surround all or part of the connection part 182 and may be fitted to the housing 170.

The housing 170 may be easily separated from the TCU housing 190 using a strap 184.

The strap 184 may comprise a fixed region 184a, a connection region 184b, and a free end region 184c.

The fixed region 184a may be fixed to the lower case 172. The fixed region 184a may be accommodated in the battery space S1. The fixed region 184a may be fixed to the lower case 172 by an adhesive or the like.

The connection region 184b may extend from the upper end of the fixed region 184a. The connection region 184b may surround the connection part 182. The connection region 184b may pass through a gap formed in the housing and surround the connection part 182.

The gap formed in the housing 170 may be formed between the upper case 171 and the lower case 172, or may be formed in the upper case 171, or may be formed in the lower case 172.

The free end region 184c may extend from the connection region 184b.

The free end region 184c may extend from the inside of the housing 170 to the upper surface of the upper case 171.

When the free end region 184c of the strap 184 is lifted, the housing 170 may be lifted upward at the portion where the strap 184 is fitted (i.e., the connection part 182), and the latch 178 and 179 may come out of the latch hole 198 and 199 formed in the TCU housing 190 and be released from the TCU housing 190.

When the free end region 184c of the strap 184 is lifted in the upper or upper front inclined direction XZ, the housing 170 may be lifted together with the strap 184 through the connection part 182 to which the strap 184 is connected.

A strap 184 fitted into the connection part 182 may penetrate the upper case 171.

A strap penetration hole 171a through which a strap 184 passes may be formed in the upper case 171.

The free end region 184c of the strap 184 may penetrate the strap penetration hole 171a.

The strap 184 passes through the strap penetration hole 171a and force may be applied in a plurality of directions.

The upper area 171b of the strap penetration hole 171a may be wider than the lower area 171c of the strap penetration hole 171a.

The strap 184 may be pulled forward and upward in an inclined direction XZ or upward direction by the operator or the operating device, and the strap 184 may pull the connection part 182 in an inclined direction XZ or upwardly.

When the connection part 182 is pulled in the inclined direction XZ or upward direction, the plurality of latches 178 and 179 connected to the connection part 182 may be pulled by being attracted to the connection part 182, and the rear plate 172d on which the plurality of latches 178 and 179 are formed among the housing 170 may be lifted upward.

The battery module 160 may further comprise a cushion 186.

The cushion 186 may be attached to the outer surface of the housing 160. The cushion 186 may be attached to the lower surface and the front surface of the lower case 172.

The cushion 186 may come into contact with the TCU housing 190 and protect the battery module 160 from shock or vibration.

An inner space S3 in which a substrate 191 is accommodated may be formed in the TCU housing 190.

The substrate 191 may be accommodated in the inner space S3. When the battery module 160 is assembled, the substrate 191 may be electrically connected to the battery module 160, particularly to the power supply terminal 175.

A connector 191a that is in contact with a power supply terminal 175 may be disposed on the substrate 191. The connector 191a may be disposed on the lower surface of the substrate 191.

A pocket 192 may be formed in the TCU housing 190. The upper surface of the pocket 192 may be open.

The battery module 160 may be inserted into the pocket 192 and accommodated in the pocket 192.

A battery module space S2 may be formed inside the pocket 192 into which a battery module 160 is inserted and accommodated.

The pocket 192 may comprise a front plate part 192a, a rear plate part 192b spaced apart from the front plate part 192a in the front and rear direction X, a left plate part 192c connecting the left end of the front plate part 192a and the left end of the rear plate part 192b, and a right plate part 192d connecting the right end of the front plate part 192a and the right end of the rear plate part 192b. The pocket 192 may further comprise a lower plate part 192e forming the outer appearance of the lower surface of the pocket 192.

The front plate part 192a, the rear plate part 192b, the left plate part 192c, the right plate part 192d, and the lower plate part 192e may form a battery module space S2.

A penetration portion 194 through which a terminal seating portion 174 may pass may be formed in the TCU housing 190.

The penetration portion 194 may be formed in the pocket 192 of the TCU housing 190.

The penetration portion 194 may be formed to be open in the front and rear direction X of the pocket 192. The penetration portion 194 may be formed in the front plate part 192a of the pocket 192.

A position alignment hole for position alignment of the battery module 160 may be formed in the TCU housing 190. The position alignment hole may be formed in a pocket 192 of the TCU housing 190. The position alignment hole may be formed to be open in the front and rear direction X on the front plate part 192a of the pocket 192. A plurality of position alignment holes may be formed on the front plate part 192a of the pocket 192. The plurality of position alignment holes 196 and 197 may comprise a pair of position alignment holes 196 and 197 spaced apart in the left and right direction Y. The pair of position alignment holes 196 and 197 may comprise a left position alignment hole 196 and a right position alignment hole 197.

A latch hole may be formed in the TCU housing 190 into which the protruding bodies 178b of a plurality of latches 178 and 179 are inserted and restrained. The latch hole may be formed in a pocket 192 of the TCU housing 190. The latch hole may be formed in a rear plate part 192b of the pocket 192 to be open in the front and rear direction X. A plurality of latch holes may be formed in the rear plate part 192b of the pocket 192.

The plurality of latch holes 198 and 199 may comprise a pair of latch holes 198 and 199 spaced apart in the left and right direction Y. The pair of latch holes 198 and 199 may comprise a left latch hole 198 and a right latch hole 199.

FIG. 11 is a cross-sectional view illustrating a state where the latch is restrained in a pocket according to the present embodiment.

FIG. 11 (a) is a cross-sectional view illustrating a state where a center body is inserted into a latch hole, and FIG. 11 (b) is a cross-sectional view illustrating a state where a side body is inserted into a latch hole.

The upper end 178f of the center body 178c may be horizontal. The upper end 178f of the center body 178c may be parallel to the upper end 198a of the region in which the center body 178c is inserted among the latch holes 198.

The rear surface of the elastic body 178a may be vertical.

The upper end 178f of the center body 178c may be perpendicular to the rear surface of the elastic body 178a.

The center body 178c may be inserted into the latch hole 198 and firmly restrained in the pocket 192, and arbitrary removal of the latch 178, 179 may be minimized.

The upper end 178g of the side body 178d may be inclined. The upper part of the side body 178d may face the inclined direction toward the rear upper side.

The upper end 178g of the side body 178d may not be perpendicular to the rear surface of the elastic body 178a and may have an obtuse angle with the rear surface of the elastic body 178a.

The upper end 178g of the side body 178d may have an acute angle with the upper end 198b of the region in which the side body 178d is inserted among the latch holes 198.

The height of the upper end 178g of the side body 178d may be different from the height of the upper end 178f of the center body 178c. The height of the upper end 178g of the side body 178d may be lower than the height of the upper end 178f of the center body 178c.

The height H1 of the upper end 198a of the region where the center body 178c is inserted among the latch holes 198 may be different from the height H2 of the upper end 198b of the region where the side body 178d is inserted among the latch holes 198.

The upper end 198a of the region where the center body 178c is inserted among the latch holes 198 and the upper end 198b of the region where the side body 178d is inserted among the latch holes 198 may form a step.

The upper height H2 of the region 198b in which the side body 178d is inserted among the latch holes 198 may be lower than the upper height H1 of the region 198a in which the center body 178c is inserted among the latch holes 198.

The upper end 178g of the side body 178d may smoothly pass over the upper end of the latch hole 198 formed in the pocket 192. When the connection part 182 is raised by the strap 184, the side body 178d may easily come out of the latch hole 198, 199. In other words, the operator or the operating device may withdraw the battery module 160 from the TCU housing 190 with little force.

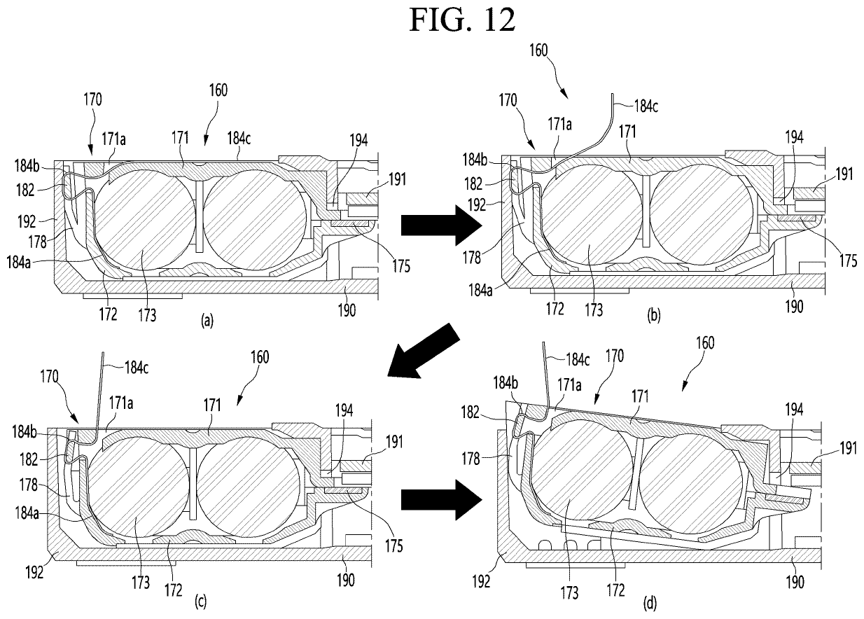

FIG. 12 is a cross-sectional view illustrating the process of removing a battery module from a TCU housing according to the present embodiment.

FIG. 12 (a) is a cross-sectional view of a state where the battery module is assembled into the TCU housing and the free end region 184c of the strap 184 is seated on the upper surface of the housing 170.

FIG. 12 (b) is a cross-sectional view when a portion of the free end region 184c of the strap 184 is erected obliquely.

FIG. 12 (c) is a cross-sectional view when the free end region 184c of the strap 184 is erected more vertically than in the case of FIG. 12 (b).

FIG. 12 (d) is a cross-sectional view when the strap 184 is lifted upward and the battery module 160 is being separated from the pocket 192.

The operator or the operating device may grasp the free end region 184c of the strap 184 as illustrated in FIG. 12 (a), and then erect it obliquely as illustrated in FIG. 12 (b), and then erect it approximately vertically as illustrated in FIG. 12 (c).

The operator or the operating device may hold and raise the free end region 184c of the strap 184 as illustrated in FIG. 12 (12), and the connection part 182 into which the connection region 184b of the strap 184 is fitted may be raised by being guided by the strap 184 as illustrated in FIG. 12 (d), and the housing 160 may be gradually pulled out of the pocket 192 while being disposed obliquely with respect to the pocket 192.

According to the present embodiment, since the latch of the housing is snap-fit-coupled to the TCU housing and restrained, the battery module may be easily mounted on the TCU housing, and a battery module cover for covering the battery module is not required, thereby minimizing the number of parts of the telematics terminal.

Additionally, since the housing is separated from the TCU housing using a strap, the battery module may be easily separated from the TCU housing.

Additionally, the lower and upper cases may be easily pulled out of the TCU housing by simply pulling the straps.

Additionally, the strap may exert force in a plurality of directions, and thus the latch may more easily be pulled out of the latch hole in the TCU housing.

Additionally, the upper end of the center body of the latch is perpendicular to the rear surface of the elastic body, so that the latch may be firmly assembled into the pocket when the battery module is mounted.

In addition, since the upper end of the side body of the latch has an obtuse angle with the rear surface of the elastic body, the latch may be easily pulled out of the latch hole when the battery module is pulled out. The above description is merely an illustrative explanation of the technical idea of the present disclosure, and various modifications and variations will be possible to those skilled in the art without departing from the essential characteristics of the present disclosure.

Accordingly, the embodiments disclosed in the present disclosure are not intended to limit the technical idea of the present disclosure, but are for illustrative purposes, and the scope of the technical idea of the present disclosure is not limited by these embodiments.

The scope of protection of the present disclosure should be interpreted in accordance with the claims below, and all technical ideas within the equivalent scope should be interpreted as being comprised in the scope of rights of the present disclosure.

What is claimed is:

1. A battery module comprising:
a housing having a battery space formed between an upper case and a lower case;
a plurality of latches extending from the housing;
a connection portion connected to the plurality of latches; and
a strap connected to the connection portion.

2. The battery module of claim 1,
wherein the housing is snap-fit coupled to a TCU housing to which the latch is restrained, and
wherein the housing is separated from the TCU housing using the strap.

3. The battery module of claim 1,
wherein a strap penetration hole through which the strap penetrates is formed in the upper case, and
wherein the strap is capable of applying force in a plurality of directions.

4. The battery module of claim 3,
wherein an upper area of the strap penetration hole is larger than a lower area of the strap penetration hole.

5. The battery module of claim 1,
wherein a terminal seating portion is formed in the housing, and wherein the battery module comprises a power supply terminal disposed on the terminal seating portion.

6. The battery module of claim 5,
wherein the housing further comprises a guide that is spaced apart from the terminal seating portion and is inserted into a position alignment hole formed in the TCU housing.

7. The battery module of claim 1,
wherein the latch comprises an elastic body extending from the housing and a protruding body protruding from the elastic body.

8. The battery module of claim 1,
wherein the protruding body comprises a center body and a pair of side bodies,
wherein an upper end of the center body is perpendicular to a rear surface of the elastic body, and
wherein an upper end of the side body has an obtuse angle with the rear surface of the elastic body.

9. A telematics terminal having a battery module comprising:
a battery module;
a TCU housing formed with a pocket in which the battery module is detachably mounted and an inner space formed therein; and
a substrate accommodated in the inner space,
wherein the battery module comprises:
a housing having a battery space formed between an upper case and a lower case;
a plurality of latches extended from the housing;
a connection portion connected to the plurality of latches; and
a strap connected to the connection portion.

10. The telematics terminal having a battery module of claim 9,
wherein a latch hole into which a protruding body of the latch is inserted and restrained is formed in the TCU housing,
wherein the strap comprises:
a fixed region fixed to the lower case,
a connection region wrapping the connection portion, and
a free end region extended from the connection region, and
wherein the housing allows the latch to be released from the latch hole when the free end region is lifted.

11. The telematics terminal having a battery module of claim 9,
wherein a strap penetration hole through which the strap penetrates is formed in the upper case, and
wherein an upper area of the strap penetration hole is larger than a lower area of the strap penetration hole.

12. The telematics terminal having a battery module of claim 9,
wherein a terminal seating portion is protruded in the housing,
wherein the battery module further comprises a power supply terminal disposed on the terminal seating portion, and
wherein a penetration portion through which the terminal seating portion penetrates is formed in the pocket.

13. The telematics terminal having a battery module of claim 12,
wherein a guide spaced apart from the terminal seating portion is protruded in the lower case, and
wherein a position alignment hole into which the guide is inserted is formed in the pocket.

14. The telematics terminal having a battery module of claim 9,
wherein the latch comprises:
an elastic body extending from the housing; and
a protruding body protruding from the elastic body.

15. The telematics terminal having a battery module of claim 14,
wherein the protruding body comprises a center body and a pair of side bodies,
wherein an upper end of the center body is perpendicular to a rear surface of the elastic body, and
wherein an upper end of the side body has an obtuse angle with the rear surface of the elastic body.
